(19) United States
(12) Patent Application Publication
(10) Pub. No.: US 2026/0168517 A1
(43) Pub. Date: Jun. 18, 2026

(54) TANDEM GUIDE VANE COMPONENT FOR A STATOR STAGE AND METHOD FOR MANUFACTURING A TANDEM GUIDE VANE COMPONENT

(71) Applicant: Rolls-Royce Deutschland Ltd & Co KG, Blankenfelde-Mahlow (DE)

(72) Inventors: Stefan MIERSCH, Berlin (DE); Michael SCHULZE, Zeuthen (DE)

(21) Appl. No.: 19/423,259

(22) Filed: Dec. 17, 2025

(30) Foreign Application Priority Data
Dec. 18, 2024 (DE) 102024138652.5

(51) Int. Cl. F04D 29/54; B22F 3/22; F04D 29/64

(52) U.S. Cl. CPC F04D 29/542; B22F 3/225; F04D 29/644

(57) ABSTRACT

A tandem guide vane component for a stator stage of a turbomachine compressor has a front guide vane, a rear guide vane, a platform and a fastening structure. The front guide vane is assigned to a first tandem guide vane pair and the rear guide vane is assigned to a second tandem guide vane pair that is adjacent in the circumferential direction. The front guide vane and rear guide vane are offset in the circumferential direction with respect to one another such that they do not overlap in the circumferential direction.

### CROSS-REFERENCE TO RELATED APPLICATIONS

This application claims the benefit of German patent application DE 102024138652.5, filed on Dec. 18, 2024, which is hereby incorporated by reference in its entirety.

### BACKGROUND

### Technical Field

The present disclosure relates to a tandem guide vane component for a stator of a gas turbine engine.

### Description of the Related Art

A tandem guide vane component of the type mentioned at the beginning is disclosed, for example, in US 2015/027131 A1.

U.S. Pat. No. 11,338,400 B2, US 2020/0392967 A1, US 2024/0183279 A1 and DE 102016113568 A1 each disclose tandem guide vane components and the manufacture thereof.

For advantageous aerodynamic efficiency, parameters such as, for example, gap width and vane overlap of the tandem guide vanes are optimized for the respective concept. These parameters may limit the space available for manufacture and may limit the technically available and implementable manufacturing methods.

There is a need to provide an improved tandem guide vane component.

### SUMMARY

The scope of the present disclosure is defined solely by the appended claims and is not affected to any degree by the statements within this summary.

In a first aspect, a tandem guide vane component for a stator stage of a turbomachine compressor is proposed, comprising a front guide vane, a rear guide vane, a platform and a fastening structure. Provision is made for the front guide vane and rear guide vane to be offset in the circumferential direction with respect to one another such that they do not overlap in the circumferential direction. Provision is made for the tandem guide vane component to comprise exactly one front guide vane and exactly one rear guide vane. The two guide vanes do not belong to a common tandem guide vane pair. The front guide vane of the tandem guide vane component is assigned to a first tandem guide vane pair. The rear guide vane of the tandem guide vane component is offset tangentially in the circumferential direction with respect to the front guide vane such that it is assigned to a second tandem guide vane pair that is adjacent in the circumferential direction.

The disclosure includes the finding that, as a result of this tangential offset of the front and rear guide vanes, advantageous manufacture is allowed. This is attributable to the fact that the accessibility of the surfaces of the front and rear guide vanes is improved, and as a result, the surfaces may be reached better by machining tools.

Tandem guide vane components are exposed to high mechanical and thermal loads, and are therefore advantageously manufactured from resistant materials. At the same time, high shape and geometric accuracy are required, making finishing work challenging, in the case of the resistant materials that are used.

It does not have to be necessary for a tandem guide vane pair that belongs together, meaning two guide vanes that are arranged substantially axially one behind the other and/or two guide vanes intended to be considered as an aerodynamically cooperating unit, to have to be arranged on a common platform. As a result of the proposed, tangentially offset arrangement, an improvement in terms of the mechanical loading during operation of the tandem guide vane component may be achieved. The zone with increased loading is now advantageously located on the platform within the component and no longer in a transition zone or at a joint between two tangentially adjacent guide vane pairs.

An aerodynamically cooperating unit is understood in this case as meaning that the gap formed between the tandem guide vane pair on account of its nozzle shape results in acceleration of the flow and in stabilization of the boundary layer on the rear guide vane of the tandem guide vane pair and the deflection and the deceleration of the flow may be increased compared with conventional stators. The gap between a tandem guide vane pair is preferably configured to be small, in order to achieve aerodynamic properties that are as advantageous as possible. The gap between the two guide vanes of a tandem guide vane pair is smaller than the gap between two tandem guide vane pairs that are adjacent in the circumferential direction.

In some embodiments, the gap formed between two guide vanes of the tandem guide vane component is preferably larger than the gap between the tandem guide vane pair. The front guide vane and the rear guide vane of a tandem guide vane component preferably form a gap that is larger than a gap that is formed between the front guide vane and a rear guide vane of a tandem guide vane pair. The gap between the front guide vane and the rear guide vane of a tandem guide vane pair is defined preferably by the smallest spacing between a rear edge of the front guide vane and a suction side of the rear guide vane. The term gap in relation to the tandem guide vane component denotes in a spacing between the rear edge of the front guide vane and a front edge of the rear guide vane of the tandem guide vane component in the circumferential direction.

In some embodiments, provision is made for the platform to form a boundary contour in relation to a tandem guide vane component that is adjacent in the circumferential direction. The platform may have a boundary contour that is able to be brought into contact with a complementary boundary contour of a platform of a tandem guide vane component that is adjacent in the circumferential direction. The boundary contour may advantageously have a course that extends at least partially in the circumferential direction. As a result of a tandem guide vane pair being divided between two platforms by means of a boundary contour, improved accuracy in the orientation, relative to one another, of the platforms that are in contact in the circumferential direction may be achieved. This is advantageous since the orientation of the tandem guide vane pair influences the aerodynamic properties of the stator stage. A first boundary contour of a first tandem guide vane component may be configured such that it may be put into a form fit with a second boundary contour of a second tandem guide vane component. The form fit may be effective in the axial direction and/or in the circumferential direction.

The first boundary contour may comprise a first form-fit feature, and the second boundary contour may comprise a second, complementary form-fit feature that is able to be engaged with the first form-fit feature. The form-fit feature may comprise, for example, a contact surface that is arranged and configured to be brought into contact with a complementary contact surface of an adjacent boundary contour and to prevent a relative movement between the adjacent boundary contours in the axial direction. The boundary contour advantageously makes it possible to orient the tandem guide vane components with respect to one another with a high level of accuracy in the axial direction and in the circumferential direction with relatively little effort. For example, the boundary contour may be Z-shaped or serrated, although other designs are possible.

In a second aspect, a tandem guide vane segment is proposed, comprising: a plurality of tandem guide vane components, wherein the front guide vanes form a front stator vane row that is offset axially upstream and the rear guide vanes form a rear stator vane row that is offset axially downstream, wherein two adjacent tandem guide vane components form a tandem guide vane pair, wherein a rear guide vane of a first tandem guide vane component respectively forms, with a front guide vane of a second, adjacent tandem guide vane component, a tandem guide vane pair.

A tandem guide vane segment of this kind has the advantage that, as a result of the combination, pre-assembly of tandem guide vane components to form tandem guide vane segments, a controlled spacing is produced between the individual tandem guide vane components of a tandem guide vane segment. The probability of twisting on account of the relatively large circumferential length compared with individual tandem guide vane components is advantageously reduced.

In some embodiments, a stator stage for a turbomachine compressor is proposed, comprising: a plurality of tandem guide vane segments, wherein the front guide vanes form a front stator vane row that is offset axially upstream and the rear guide vanes form a rear stator vane row that is offset axially downstream, wherein a rear guide vane of a first tandem guide vane component respectively forms, with a front guide vane of a second, adjacent tandem guide vane component, a tandem guide vane pair. This means that two adjacent tandem guide vane components respectively form a tandem guide vane pair.

To achieve the required tolerances and/or configuration, it may be advantageous to combine tandem guide vane segments with different segment lengths to form a stator stage.

In some embodiments, a turbomachine compressor is proposed, comprising a plurality of stator stages.

In some embodiments, a gas turbine engine is proposed, having a turbomachine compressor.

In a third aspect, a method for producing a tandem guide vane component is proposed, comprising: producing a front guide vane, located upstream, in a first tangential portion; producing a rear guide vane, located downstream, in a second tangential portion, wherein the front guide vane located upstream and the rear guide vane located downstream do not overlap in the circumferential direction. Provision is made for it not the front and rear guide vanes of a cohesive tandem guide vane pair that are located on a platform of a tandem guide vane component but in each case a front and a rear guide vane of two adjacent tandem guide vane pairs. While it is possible to achieve an aerodynamically advantageous small spacing between two guide vanes of a tandem guide vane pair, a larger spacing, a gap width, is achieved—advantageously in terms of manufacture—between the guide vanes of a tandem guide vane component. The larger spacing between the guide vanes of a tandem guide vane component allows better accessibility for necessary machining steps.

In some embodiments, provision is made for the production of the front guide vane located upstream and rear guide vane located downstream to take place by means of a separating, preferably cutting, manufacturing method. In this case, the desired shape and surface quality of the front and rear guide vanes is created.

In some embodiments, further parts of the tandem guide vane component, or the entire tandem guide vane component, are produced by means of the separating, preferably cutting, manufacturing method.

In some embodiments, provision is made for the production of the front guide vane located upstream and rear guide vane located downstream to take place by means of a primary forming method. The primary forming method may be a moulding method, preferably an injection-moulding method, for example a metal powder injection-moulding method. Complex components may be created using such injection-moulding methods. Tandem guide vane components with relatively large gap widths may be demoulded more easily in injection-moulding methods. In components produced by injection-moulding methods, use is generally made of materials that are suitable for machining steps, machining steps upstream or downstream of the injection-moulding method, that are necessary for the production of tandem guide vane components. Such machining steps include, for example, surface treatments and joining methods.

In some embodiments, further parts of the tandem guide vane component, or the entire tandem guide vane component, are produced by means of the primary forming manufacturing method.

In some embodiments, additive manufacturing methods for partially or fully producing the tandem guide vane component, the front guide vane located upstream and the rear guide vane located downstream, may be used.

In some embodiments, the production of a tangential boundary contour is provided. The boundary contour is formed, for example, by a separating, cutting, manufacturing method, for example milling. The production of the tangential boundary contour may involve the production of a form-fit feature. In the case of two tandem guide vane components that are adjacent in the circumferential direction, two engaged form-fit features, that are directed in the circumferential direction with respect to one another, form a form fit. The boundary contour, the form-fit feature, makes it possible to orient the tandem guide vane components with respect to one another with a greater level of accuracy in the axial direction and/or in the circumferential direction with relatively little effort. For example, the boundary contour may be Z-shaped or serrated, although other designs are possible.

In some embodiments, the production of a fastening structure is provided. The fastening structure is formed, for example, by a separating, cutting, manufacturing method, for example milling.

In some embodiments, there is no production of the fastening structure of the tandem guide vane component. In this case, the tandem guide vane component is referred to as an interim tandem guide vane component.

In a fourth aspect, a method for producing a tandem guide vane segment is proposed, comprising: joining together a plurality of tandem guide vane components by means of a joining method, preferably by welding or brazing, wherein the rear guide vane of a first tandem guide vane component forms, with a front guide vane of a second, adjacent guide vane component, a tandem guide vane pair.

The individual tandem guide vane components are arranged next to one another in the circumferential direction and joined together, pre-assembled, to form tandem guide vane segments. Besides the advantages already mentioned for tandem guide vane segments, pre-assembled tandem guide vane segments may advantageously shorten downstream production steps, assembly steps. Individual interim tandem guide vane components are joined together, pre-assembled, to form an interim tandem guide vane segment. In a further manufacturing step, the production of a segment fastening structure is provided. The segment fastening structure is formed, for example, by a separating, cutting, manufacturing method, for example milling. The production of the fastening structure in a later manufacturing step, after the joining together of the interim tandem guide vane components to form an interim tandem guide vane segment, allows an advantageous reduction in tolerances, an offset along the fastening structure compared with the production of the fastening structure during the production of the tandem guide vane component.

The first and last component, in the circumferential direction, of the tandem guide vane segment are in the form of segment end components. In this case, the last component in the circumferential direction, the segment end component, comprises a segment boundary contour and a front guide vane. The first component in the circumferential direction, the segment end component, comprises a rear guide vane and a segment boundary contour. As a result of the segment end components, tolerances that arise in the circumferential direction may advantageously be compensated.

In a fifth aspect, a method for producing a stator stage is proposed, comprising: assembling a plurality of tandem guide vane segments. The tandem guide vane segments may, to this end, be arranged next to one another in the circumferential direction and fixed by the fastening structure in the housing. The tandem guide vane segments may form a stator stage of an axial compressor, that comprises a front and a rear guide vane row that are formed by tandem guide vane pairs.

In some embodiments, the individual tandem guide vane segments are joined together to form a complete ring by means of a joining method, preferably by welding or brazing. The complete ring may form a stator stage of an axial compressor, that comprises a front and a rear guide vane row that are formed by tandem guide vane pairs.

In some embodiments, the individual tandem guide vane components are assembled in the circumferential direction and fixed by the fastening structure in the housing. The tandem guide vane components may form a stator stage of a compressor, an axial compressor, that comprises a front and a rear guide vane row that are formed by tandem guide vane pairs.

In some embodiments, the individual tandem guide vane components are joined together to form a complete ring by means of a joining method, preferably by welding or brazing. The complete ring may form a stator stage of a compressor, an axial compressor, that comprises a front and a rear guide vane row that are formed by tandem guide vane pairs.

### BRIEF DESCRIPTION OF THE DRAWINGS

The present disclosure will be explained in greater detail below by means of a plurality of example embodiments and with reference to the figures, in which:

FIG. 1 shows a simplified schematic sectional illustration of a gas turbine engine.

FIG. 2 shows a plan view of a tandem guide vane component.

FIG. 2a shows the arrangement of a plurality of tandem guide vane components of FIG. 2.

FIG. 3 shows a side view of a tandem guide vane component.

FIG. 4 shows two tandem guide vane segments arranged alongside one another, that have been joined together from a plurality of tandem guide vane components.

FIG. 5 shows a simplified schematic illustration of a stator stage in that tandem guide vane components are arranged.

FIG. 6 shows a simplified flow chart of the manufacturing steps for producing a tandem guide vane segment.

FIG. 7 shows a simplified flow chart of the assembly steps for producing a stator stage.

### DETAILED DESCRIPTION

Aspects and embodiments of the present disclosure will now be discussed with reference to the accompanying figures. Further aspects and embodiments will be apparent to those skilled in the art.

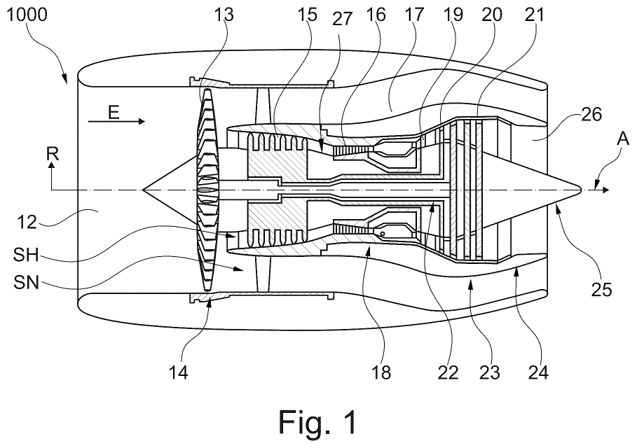

FIG. 1 schematically shows, in a sectional illustration, a gas turbine engine 1000. Engine components are arranged successively along an engine longitudinal axis A of the gas turbine engine 1000. At the inlet 12, air is drawn in along an inlet direction E by means of a fan 13. This fan 13 is arranged in a fan housing 14 and is driven by a turbine 23 via a rotor shaft 22. The turbine 23 adjoins a compressor, referred to as a turbomachine compressor 27, that has a low-pressure compressor 15 and a high-pressure compressor 16, and a medium-pressure compressor. To generate thrust, the fan 13 supplies the low-pressure compressor 15 and the high-pressure compressor 16 and the bypass duct 17 with air. This results in a main flow SH, that passes through the core of the gas turbine 1000, and a secondary flow SN, that passes through the bypass duct 17. The air compressed in the compressor 15, 16 is mixed with fuel in the combustion chamber 18 and combusted. By way of the generated hot gas, the turbine 23, that may include a high-pressure turbine 19, a medium-pressure turbine 20 and a low-pressure turbine 21, is driven. The energy released during the combustion is used by the turbine 23 to drive a rotor shaft 22 and to drive the fan 13, in order then to generate the necessary thrust via the air conveyed through the bypass duct 17. Both the secondary flow from the bypass duct 17 and the main flow flow out via an outlet 26. In this case, the outlet 26 usually has a thrust nozzle with a centrally arranged outlet cone 25. For noise reduction, a mixer is provided, as part of a mixer group 24, in the region of the outlet. As a result of the particular contour of the mixer, the main stream from the core flow and the secondary flow from the bypass duct 17 of the gas turbine 1000 are deflected and mixed such that the resultant swirls reduce the audible noise level. The proposed solution may be used in gas turbines of different designs, for example in any desired kind of gas turbine engine, for example in an open-rotor or a turboprop engine or a geared turbofan.

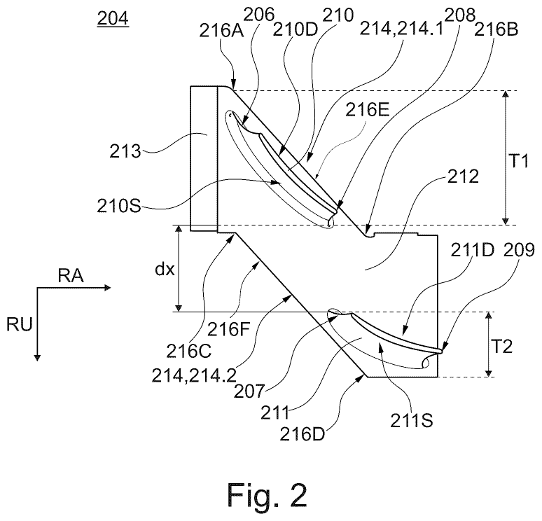

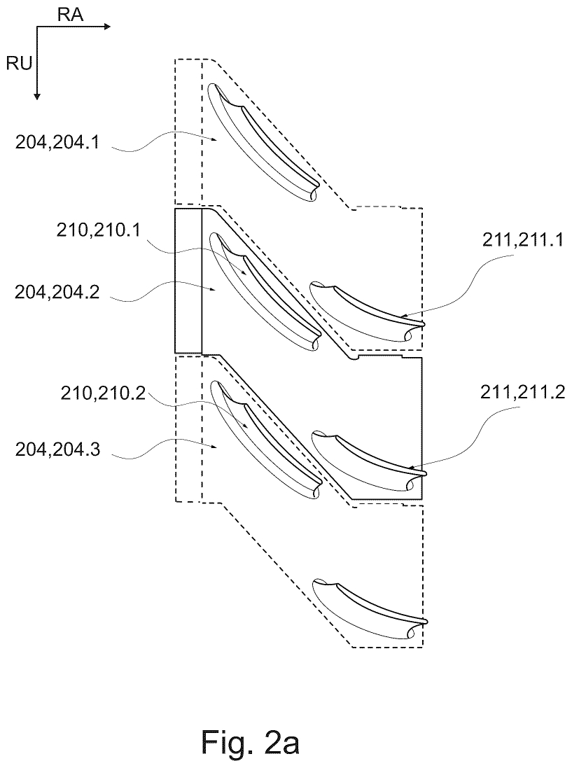

FIG. 2 schematically shows the plan view of a tandem guide vane component 204 of. Formed on a platform 212 is a front guide vane 210 and a rear guide vane 211, where the terms “front” and “rear” relate to an axial direction RA, that is parallel to the engine longitudinal axis A. The front guide vane 210 includes a front edge 206 and a rear edge 208. The rear guide vane 211 comprises a front edge 207 and a rear edge 209. To achieve advantageous aerodynamic properties, the guide vanes are produced with high shape and geometric accuracy. This is the case particularly for the edges and corners, for example the front edges 206, 207 and rear edges 208, 209 of the guide vanes. The front guide vane 210 is arranged in a first tangential portion T1 and the rear guide vane 211 is arranged in a second tangential portion T2. Between the front guide vane 210 and the rear guide vane 211, a gap is formed, having a gap width dX in a circumferential direction RU. The gap width dX is advantageously configured to be large in order to allow easier accessibility for tools and necessary machining steps.

The platform 212 is configured with boundary contours 214, namely a first boundary contour 214.1 and a second boundary contour 214.2, opposite thereto in the circumferential direction RU, that form a contact surface with respect to the tandem guide vane components 204 that are respectively adjacent in the circumferential direction RU, or the boundary contours 214 thereof. The boundary contour 214 of the platform 212 is advantageous with the arrangement and orientation of individual tandem guide vane components 204 with respect to one another. With two tandem guide vane components 204 that are adjacent in the circumferential direction RU, the boundary contours 214 that are directed towards one another in the circumferential direction RU form a form fit. The circumferential direction RU corresponds to the tangential direction. The boundary contour 214 makes it possible to orient the tandem guide vane components 204 with respect to one another with a high level of accuracy in the axial direction RA and in the circumferential direction RU with relatively little effort.

For example, the boundary contour may be Z-shaped or serrated, although other designs are possible. Also formed on the platform 212 is a fastening structure 213. This fastening structure 213 is advantageous for fastening the tandem guide vane components 204 in the stator housing. To form a form fit, the boundary contour 214 may have one or more form-fit features 216. In the present case, the first boundary contour 214.1 has a first form-fit feature 216A and a second form-fit feature 216B and the second boundary contour 214.2 has a third form-fit feature 216C and a fourth form-fit feature 216D. The first form-fit feature 216A and the third form-fit feature 216C correspond to one another, i.e. are formed in a complementary manner to one another such that the first form-fit feature 216A of a first boundary contour 214.1, upon contact with the third form-fit feature 216C of a second boundary contour 214.2 of a tandem guide vane component 204 that is adjacent in the circumferential direction RU, prevents relative movability with respect to one another in at least one direction, for example, as in the present case, the axial direction RA.

As a result of the first form-fit feature 216A being configured as a convex inflection point and the third form-fit feature 216C being configured as a concave inflection point, a defined stop for assembly is advantageously formed, this defining a fixed relative reference between two adjacent tandem guide vane components 204. The same applies analogously for the second form-fit feature 216B and the fourth form-fit feature 216D. At the same time, other form-fit features 216 may be chosen, that are configured to prevent a relative movement between two adjacent boundary contours 214, in the axial direction RA.

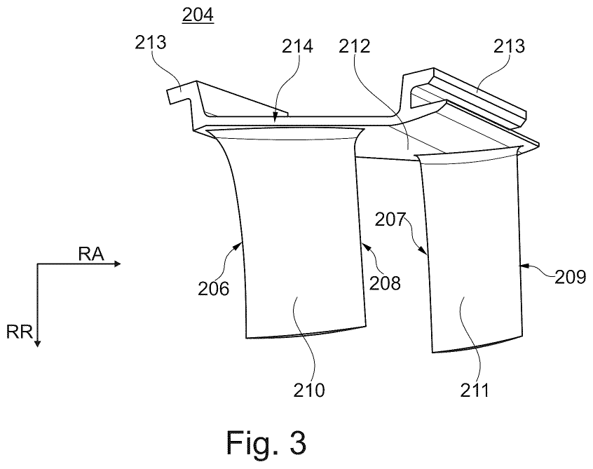

The inflection points described here, the form-fit feature 216 may include, as in this case at the first boundary contour 214.1, a contact surface 216E that is able to be brought into contact with a complementary contact surface 216F of a form-fit feature of an adjacent boundary contour 214 (for example the boundary contour 214.2) in order to prevent a relative movement in the axial direction RA and to allow in a reference surface for precise and accurate assembly. FIG. 2a schematically shows, for clarification, the arrangement of a plurality of tandem guide vane components 204 from FIG. 2 in the circumferential direction RU. FIG. 3 schematically shows the side view of the tandem guide vane component 204.

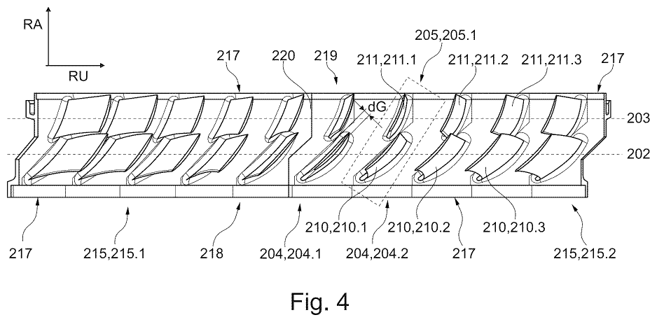

FIG. 4 schematically shows two assembled tandem guide vane segments 215. In this case, a single tandem guide vane segment 215 has been joined together from a plurality of tandem guide vane components 204. By way of example, a first tandem guide vane component 204.1 and a second tandem guide vane component 204.2 are shown here, that are arranged adjacently in the circumferential direction RU and form a first tandem guide vane pair 205.1.

In general, two tandem guide vane components 204 that are adjacent in the circumferential direction RU respectively form a tandem guide vane pair 205. The first tandem guide vane pair 205.1 consists of a first, front guide vane 210.1 of the second tandem guide vane component 204.2 and of a first, rear guide vane 211.1 of the first, adjacent tandem guide vane component 204.1. The front guide vanes 210 of all the tandem guide vane components 204 collectively form a front guide vane row 202 and the rear guide vanes 211 of all the tandem guide vane components collectively form a rear guide vane row 203. The front guide vane 210 and rear guide vane 211 of the tandem guide vane pair 205 may overlap, in an axial direction RA and/or in a circumferential direction RU.

The front guide vane 210 and rear guide vane 211 of the tandem guide vane component 204 do not overlap in the circumferential direction RU in order to create an appropriate spacing for the tools that are used, for example, for the machining steps during production. Formed between the rear edge 208 of the front guide vane 210 and a suction side 211S of the rear guide vane 211 of the tandem guide vane pair 205 is a gap having a gap width dG. The gap width dG may be considered to be the smallest spacing between the front guide vane 210 and the rear guide vane 211. The gap width dG between a front guide vane 210 and rear guide vane 211 of a tandem guide vane pair 205 is preferably configured to be small, in order to achieve aerodynamic properties that are as advantageous as possible.

Formed at the front and rear edge in the axial direction RA of the tandem guide vane segment 215 is a segment fastening structure 217. The first and last component, in the circumferential direction RU, of the tandem guide vane segment 215 may be in the form of a segment end component 218, 219. In this case, the last component in the circumferential direction, the segment end component 218, includes a segment boundary contour 220 and a front guide vane 210. The first component in the circumferential direction, the segment end component 219, includes a rear guide vane 211 and a segment boundary contour 220.

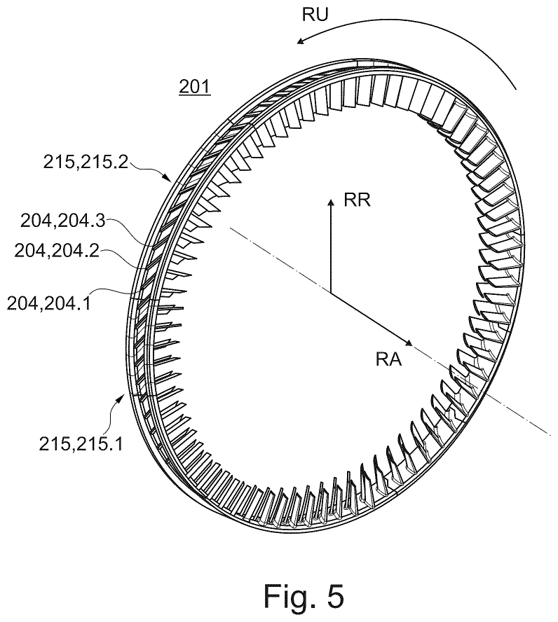

FIG. 5 schematically shows a stator stage 201. The stator stage 201 is constructed from tandem guide vane segments 215, of that, by way of example, a first tandem guide vane segment 215.1 and a second tandem guide vane segment 215.2 are labelled here. The individual tandem guide vane segments 215 are constructed from a plurality of tandem guide vane components 204. The number of tandem guide vane components 204 that form a tandem guide vane segment 215 may vary depending on the requirements.

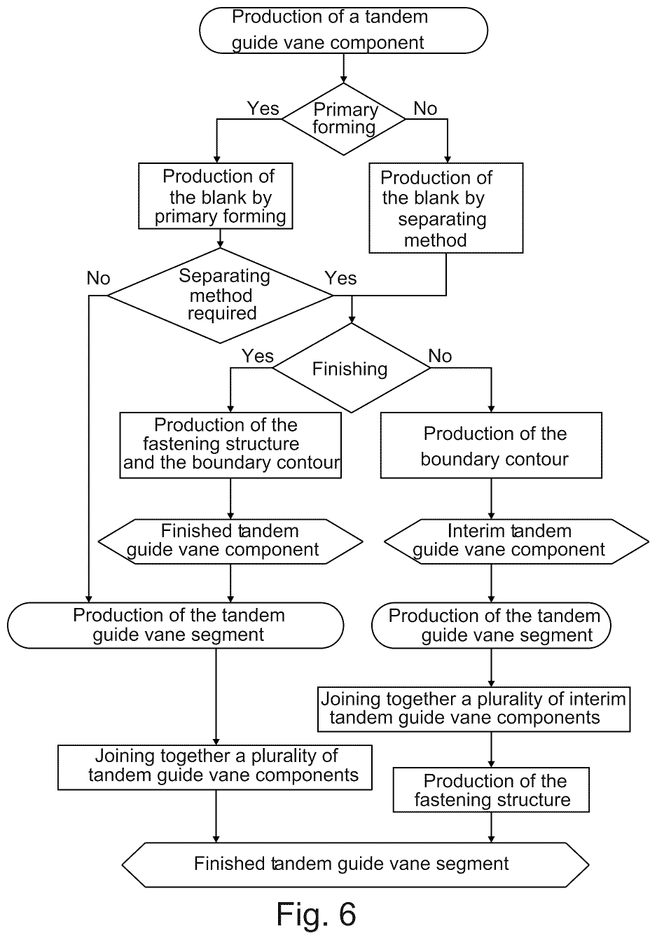

FIG. 6 shows a flow chart for the production of a tandem guide vane segment 215. The production of the tandem guide vane component 204 takes place in a first production step by primary forming or by a separating method. During production by means of primary forming, the production of the front guide vane 210 located upstream and rear guide vane 211 located downstream takes place preferably by a moulding method, particularly preferably by an injection-moulding method, for example a metal powder injection-moulding method.

Depending on the quality of the surfaces and the shape accuracy of the geometries, in a further production step, the desired shape and surface quality of the front guide vane 210 located upstream and rear guide vane 211 located downstream are created by means of a separating, preferably cutting, manufacturing method. If the quality and surface quality have already been achieved after primary forming, no further production step is required. The tandem guide vane component may be produced without primary forming, but by means of a separating method. The blank produced by primary forming or by a separating method may be processed to form a finished tandem guide vane component 204 in that the fastening structure 213 and the boundary contour 216 are created with the aid of a separating, preferably cutting, manufacturing method. The processing of the blank results in an interim tandem guide vane component 221.

In this case, the boundary contour 216 is produced, but not the fastening structure 213. A plurality of tandem guide vane components 204 are joined together by means of a joining method, preferably by welding or brazing, and form a tandem guide vane segment 215. A tandem guide vane pair 205 is formed by connecting two adjacent tandem guide vane components 204. The individual tandem guide vane components 204 are arranged next to one another in the circumferential direction RU and joined together to form tandem guide vane segments 215. The joining together by means of a joining method results in a controlled spacing between the individual tandem guide vane components 204. Tandem guide vane segments 215 afford the advantage that twisting on account of the greater circumferential length compared with the tandem guide vane component 204 is prevented. A plurality of interim tandem guide vane components 221 are joined together by means of a joining method, preferably by welding or brazing, and form an interim tandem guide vane segment 222. In a further production step, the interim tandem guide vane segment 222 is processed to form a tandem guide vane segment 215 in that the segment fastening structure 217 is created with the aid of a separating, preferably cutting, manufacturing method.

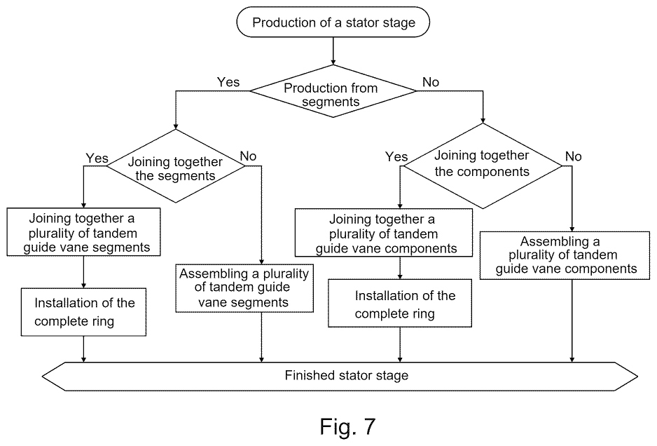

FIG. 7 shows a flow chart for the assembly of a stator stage 201. The production of the stator stage may take place either by assembling a plurality of tandem guide vane components 204 or by assembling a plurality of tandem guide vane segments 215 or by joining together a plurality of tandem guide vane segments 215 to form a complete ring. In one development, the tandem guide vane segments 215 are arranged next to one another in the circumferential direction RU and fixed by the fastening structure 213 in the housing, where the tandem guide vane segments 215 form a stator stage 201 of an axial compressor, that includes a front guide vane row 202 and a rear guide vane row 203, that are formed by tandem guide vane pairs 205. The complete ring is joined together from a plurality of tandem guide vane segments 215 by means of a joining method, preferably by welding or brazing. The complete ring forms a stator stage 201 of an axial compressor, that includes a front guide vane row 202 and a rear guide vane row 203 that are formed by tandem guide vane pairs 205.

1. A tandem guide vane component for a stator stage of a turbomachine compressor, the tandem guide vane component comprises a front guide vane, a rear guide vane, a platform and a fastening structure, wherein:
the front guide vane is assigned to a first tandem guide vane pair and the rear guide vane is assigned to a second tandem guide vane pair that is adjacent in the circumferential direction; and
the front guide vane and rear guide vane are offset in the circumferential direction with respect to one another such that they do not overlap in the circumferential direction.

2. The tandem guide vane component of claim 1, wherein the platform forms a boundary contour in relation to a tandem guide vane component that is adjacent in the circumferential direction.

3. The tandem guide vane component of claim 1, wherein the front guide vane and the rear guide vane form a gap that is larger than a gap that is formed between the front guide vane and a rear guide vane of a tandem guide vane pair.

4. A tandem guide vane segment comprising:
a plurality of tandem guide vane components of claim 1, wherein:
the front guide vanes form a front stator vane row that is offset axially upstream and the rear guide vanes form a rear stator vane row that is offset axially downstream;
two adjacent tandem guide vane components form a tandem guide vane pair; and
a rear guide vane of a first tandem guide vane component respectively forms, with a front guide vane of a second, adjacent tandem guide vane component, a tandem guide vane pair.

5. The tandem guide vane segment of claim 4, wherein the tandem guide vane segment is a stator stage of a turbomachine compressor.

6. A method for producing a tandem guide vane component, the method comprising the steps of:
producing a front guide vane, located upstream, in a first tangential portion; and
producing a rear guide vane, located downstream, in a second tangential portion, wherein the front guide vane located upstream and the rear guide vane located downstream do not overlap in the circumferential direction.

7. The method of claim 6, wherein the front guide vane located upstream and the rear guide vane located downstream are produced by a separating manufacturing method.

8. The method of claim 7, wherein the separating manufacturing method comprises cutting.

9. The method of claim 6, wherein the front guide vane located upstream and the rear guide vane located downstream are produced by a moulding method.

10. The method of claim 9, wherein the moulding method is an injection-moulding method.

11. The method of claim 10, wherein the injection-moulding method is a metal powder injection-moulding method.

12. The method of claim 6, further comprising producing a tangential boundary contour.

11. A method for producing a tandem guide vane segment, the method comprising joining together a plurality of tandem guide vane components of claim 1, wherein:
the rear guide vane of a first tandem guide vane component forms, with a front guide vane of a second, adjacent guide vane component, a tandem guide vane pair.

12. The method of claim 11, wherein the plurality of tandem guide vane components are joined together by welding or brazing.
